(19) United States
(12) Patent Application Publication
(10) Pub. No.: US 2005/0182966 A1
(43) Pub. Date: Aug. 18, 2005

(54) Secure interprocess communications binding system and methods

(76) Inventors: Duc Pham, Cupertino, CA (US); Tien Le Nguyen, Cupertino, CA (US); Pu Paul Zhang, San Jose, CA (US); Mingchen Lo, Fremont, CA (US)

Correspondence Address: GERALD B ROSENBERG;NEW TECH LAW, 285 HAMILTON AVE, SUITE 520, PALO ALTO, CA, 94301, US

(21) Appl. No.: 10/780,094

(22) Filed: Feb. 17, 2004

(51) Int. Cl. H04L 9/00

(52) U.S. Cl. 713/201

(57) ABSTRACT

The secure trust relationship between communicating programs is established at any policy defined level down to individual program instances. Policy enforcement modules installed on host computer systems support qualified encrypted communications channels between discretely selected program instances. Program instances are qualified to establish communication channels, each defined by a unique session encryption key, based on an evaluation of security data including the individual process execution contexts, user authorizations, and access attributes of the program instances. A security appliance server performs the policy-based qualification based on a mutually interdependent evaluation of the security data for both the communications channel source and target program instances.

### BACKGROUND OF THE INVENTION

1. Field of the Invention

The present invention is generally related to the establishment of secure, fine-grained trust relationships between computer systems in multi-tier distributed computing environments and, in particular, to a system and methods of securely binding interprocess communications between authenticated and authorized application programs.

2. Description of the Related Art

Distributed computing environments depend on mutually recognized trust relations among networked computer systems to establish consistent control over the access and utilization of shared resources. Conventional computer operating systems establish trust relations based simply on a shared confidence in the identity of users. Various known network security systems effectively enable a password authenticated user identity to be established within a defined network space, such as the domain controller architecture initially implemented in the Microsoft® WindowsNT® operating system and the various yellow-pages services implemented in variants of the Unix® operating system. Access control lists (ACLs) and similar user/group attributes established locally against particular computer resources then control whether any particular user is able to access and use a network resource.

Distributed computing environments have greatly increased in complexity as required to meet ever widening operational demands that arise from various topographical, commercial, and regulatory requirements. Since networked computer systems can be highly decentralized, the network security system must, as a practical matter, permit aggregated control to be delegated to and performed by a centralized security administrator. Commercial requirements for functionality, performance, and redundancy have driven adoption of multi-tiered server computing environments, employing distributed application and database servers, which require a chain of trust to be established across each tiered level. Recent regulatory requirements have increased the need to assure security over privacy related data and, further, provide an audit of access and delivery of the data. Consequently, a need to significantly improve the security throughout distributed computing environments and ensure the integrity of trust relations formed between computer systems exists.

Various efforts have been made to improve distributed security systems as an essential step toward establishing and maintaining distributed trust relations. These efforts include, among others, controlling access to specific resources by applications and other executables and securing network communications between executing applications. By controlling and, as appropriate, restricting access to certain computer resources, both untrusted and trusted but misused applications are prevented from abusing the pre-established trust relationship between the user and the computer system and, further, between computer systems within a distributed computing environment.

Restricted application access control systems typically build on existing password authenticated user identity systems in an attempt to securely manage the execution of specific application programs. For example, Fischer (U.S. Pat. No. 5,412,717) and Chan et al. (U.S. Pat. No. 6,505,300) each describe restricted execution environments implemented integral to the local operating system. The Fischer system conditions the execution of an application or other executable content within the restricted environment on local verification of a secure application signature. Known, unmodified applications are then permitted to execute subject to assigned constraints on the resources that can be accessed by the application. A constraint profile, which is locally associated with an application based on the identity of the application or application class, is used by the restricted execution environment to filter each attempt by an executing application to access a resource. Only accesses explicitly permitted are allowed to proceed. The Chan et al. system adds a fairly complex access control list capability to the constraint profile, thereby increasing the fine-grained specification of whether different resources, including other executing programs, may be accessed by an executing application.

Even where applications, as executed, are entirely well-behaved, maintaining a trust relationship across a distributed computing environment requires all communications between applications to be maintained secure against electronic attack, including interception, redirection, and eavesdropping. Secure communications are typically achieved by encrypting transmitted data, typically using a form of public key encryption. Secure communications channels are established in a variety of ways. Secure communications services can be added directly to the network operating system environment to support virtual private networks (VPNs). Typically, VPN communications systems provide a secure communications channel established between disparately located computer systems.

While preventing external attack, conventional VPNs are shared services that permit applications executing on either end-point computer system to use the communications channel, thereby remaining open to attack from other users and applications executing on the end-point systems. To reduce exposure to internal attacks, various approaches have been advanced to establish and control multiple, discretely encrypted VPN channels between the same end-point systems. For example, multiple virtual routers, each representing a separate VPN channel, can be established at each end-point. Ylonen et al. (U.S. Pat. No. 6,438,612) describes a multiple, virtual router system that supports independent encryption of each virtual router channel. Use of any particular router channel is determined by presentation of a uniquely corresponding virtual network identifier representing, effectively, an extended IP address. Multiple applications and other executable content assigned the same virtual network identifier, presumptively on the basis of equal trustworthiness, will use the same virtual router channel. Unfortunately, while increasing the number of VPNs available for use, internal attacks need only spoof a targeted virtual network identifier in order to gain access to communications between otherwise secured applications.

An alternate approach is to establish secure execution environments that internally provide for secure network communications. Conventionally, secure shell (SSH) containers are selectively executed on end-point computer systems as alternatives to the native shell execution environments provided by the host operating systems. Each secure shell, in turn, supports an execution context that enables execution of one or more contained or hosted applications. Network communications between independently hosted applications are filtered through and fully encrypted by the mutual operation of the secure shells. Thus, while the secure shells support a relatively more controlled environment for executing applications that could securely share a single communications channel, there are substantial complexity and security management issues inherent in reliably configuring multiple secure shell environments on multiple, disparately located computer systems. In addition, any internal attack that permits a compromised application to be executed as a secure shell hosted application is then able to gain access to the otherwise secure communications of the other commonly hosted applications.

Another conventional approach to ensuring secure communications between individual applications is to directly implement a security protocol, such as the secure sockets layer (SSL) protocol, as an integral part of the application itself. Conventionally, communicating applications must be specifically written to interact with and utilize the functions of the secure sockets layer implemented at each end of an otherwise shared communications channel. The available security functions, such as the ability to require certificate authentication of the participating applications, is, however, limited to the SSL API revision level commonly supported by the communicating applications.

While the SSL and, to varying extents, other application-level security protocols are accepted and used, there are inherent drawbacks to their use. Each application must be not only initially written to use a specific security protocol, but frequently revised to maintain compatibility with and support the functions available in later revisions of the protocol API. Furthermore, the available security operations are limited to the established set of procedures included in the security protocol specification. Protocol extensions to establish and enforce additional qualifications on the use of a secured channel, as may be appropriate in specific business processes, are generally not possible. Such extensions would have to be implemented as part of proprietary application programs and would therefore interoperate only between those applications.

Consequently, there is a distinct need for a secure mechanism capable of establishing trust relationships between computer systems, and further between communicating applications, in multi-tier distributed computing environments.

### SUMMARY OF THE INVENTION

Thus, a general purpose of the present invention is to provide an efficient system and methods of establishing and maintaining secure communications between authenticated and authorized application program instances.

This is achieved in the present invention by providing for the establishment of secure trust relationships at the level of individual application instances as executed on respective host computer systems interconnected by a communications network. Modules, respectively provided on the host computer systems, operate to establish encrypted communications channels between discrete application instances. Each communication channel is established using a unique session key determined based on a secure evaluation of the particular process execution contexts within which the discrete application instances are executed.

In a preferred embodiment of the present invention, the modules are executed within the kernel space of the operating system to selectively intercept communication transfers between application instances and certain components of the operating system and cipher process the communications data dependent on a session key specific to the communications channel through which the data is transferred. The session key for a communications channel is determined, during setup of the channel, by a security appliance computer system. Security data from the process execution contexts within which the application instances execute are evaluated by the security appliance against a policy database to determine whether the specific application instances are permitted to communicate under established policies. Where communication is permitted, a session key specific to the communication channel is generated and returned to the modules for use in encrypting and decrypting communications data exchanged between those particular application instances.

Thus, an advantage of the present invention is that encrypted communications channels can be established between individual processes that execute securely identified program instances. Based on policy rules, multiple processes can be bound to the same communication channel, typically where the processes exist within the some defined process context.

Another advantage of the present invention is that each program instance can be independently evaluated and, further, mutually evaluated to determine whether the programs are permitted to communicate. Participant program instances are individually examined to securely authenticate the program instance, confirm the authorization of the corresponding user to execute the program instance and examine policy defined access attributes as assigned to the user and program. This security information is further mutually evaluated whenever a program instance requests establishment of a communications channel. Thus, the present invention can constrain establishment of communications channels to only policy specified program instances and, further, to only policy specified combinations of specific program instances.

A further advantage of the present invention is that communications between bound program instances are encrypted with a session key unique to the instance shared communications channel. The policy controls, which determine whether a particular communications channel can be established, can also specify the generation of a session encryption key unique to the communications channel. Consequently, other programs are effectively precluded from redirecting, listening to or participating in the communications exchange between the securely bound program instances.

Still another advantage of the present invention is that secure program instance to program instance communications channels can be provided without requiring any modification of the programs. A policy enforcement module, which is incorporated as an operating system kernel component to intercept data transfers to and from the program instances, and a security appliance server perform all of the necessary operations to qualify and establish the encrypted communications channels. There is also no required modification to the process containers or operating system kernel of conventional general purpose operating systems to enable operation of the present invention.

Yet another advantage of the present invention is that multiple tunnel routing configurations are supported. Encryption processing may be flexibly performed on the host computer systems, utilizing any combination of native processor and hardware coprocessor encryption, or on the security appliance server. The configurations permit encrypted communications channels to be established directly between communicating hosts, with tunnel security qualification support by the security appliance server, or through the security appliance server.

### BRIEF DESCRIPTION OF THE DRAWINGS

FIG. 1 is a generalized view of a preferred operating environment for a preferred embodiment of the present invention;

FIG. 2 is a detailed view of a preferred operating interrelationship between host computer systems in accordance with a preferred embodiment of the present invention;

FIG. 3 is a generalized diagram of a security server computer system constructed in accordance with a preferred embodiment of the present invention;

FIG. 4 is a block diagram of the preferred data structure organization of signature, reference group and policy databases as implemented in a preferred embodiment of the present invention;

FIG. 5 is a flow chart showing the preferred processing of intercepted operations requests by a security server computer system in accordance with a preferred embodiment of the present invention;

FIG. 6 provides a generalized block diagram of a host computer including a preferred software architecture implementing a policy enforcement module in accordance with a preferred embodiment of the present invention;

FIG. 7 is a software block diagram of an implementation of a policy enforcement module within the kernel space of an operating system in accordance with a preferred embodiment of the present invention;

FIG. 8 is a flow chart illustrating a preferred failover operation of the policy enforcement module in performing host-based encryption in accordance with a preferred embodiment of the present invention;

FIGS. 9A-B are block diagrams illustrating multiple modes of operation including local and remote encryption, compression, and tunnel routing in accordance with a preferred embodiment of the present invention;

FIG. 10 is a flow chart illustrating the opening of an application instance in accordance with a preferred embodiment of the present invention;

FIG. 11 is a flowchart illustrating the opening of an encrypted communications channel in accordance with a preferred embodiment of the present invention;

FIG. 12 is a flowchart illustrating the operation of an encrypted communications channel in accordance with a preferred embodiment of the present invention; and

FIG. 13 is a flowchart illustrating the closure of an encrypted communications channel in accordance with a preferred embodiment of the present invention.

### DETAILED DESCRIPTION OF THE INVENTION

The present invention enables fine-grained trust relationships to be securely established for individual application instances, which is applicable both to discretely qualify the execution of individual application instances and, further, qualify and secure communications between individual application instances as executed typically on network connected host computer systems. In the following detailed description of the invention like reference numerals are used to designate like parts depicted in one or more of the figures.

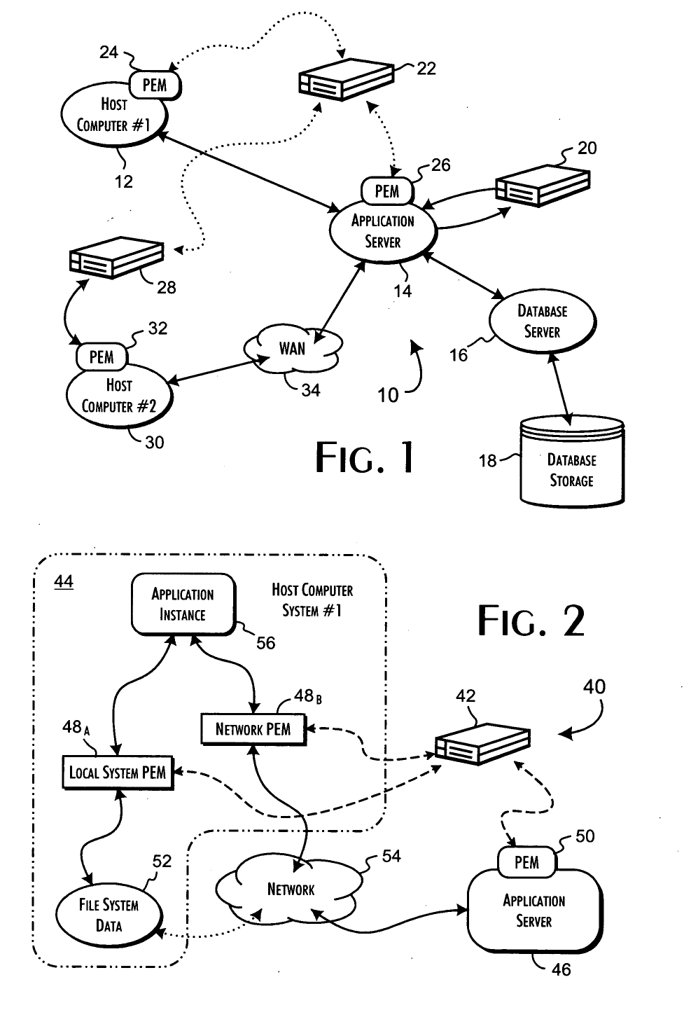

FIG. 1 illustrates a variety of the configurations 10 supported by the present invention. In general, the present invention enables specific operations of the local operating system of a host computer system to be qualified against an external database of security rules that define the permitted actions of a fine-grained security policy for a computer domain subscribed to a security server computer system. The qualified operations preferably include the loading of application instances for execution and the establishment of communications channels between individual application instances as executed on one or more of the domain host computer systems. In the preferred embodiments of the present invention, the security server computer system may be implemented as one or more security appliances that may be physically sited locally or remotely with respect to the various host computer systems.

A typical network configuration 10 employing the present invention, as generally shown in FIG. 1, provides for the secure qualification of tiered interoperating application instances. In this configuration, a host computer 12 executes a local instance of an application loaded from local or remote storage in a defined process context. Initial execution of the application instance is authorized and authenticated relative to the process context. This local application instance establishes a securely qualified communication channel with another similarly authorized and authenticated application instance, executed on an application server 14 to access, through a database server 16, data stored in a database 18. The data transferred between the application server 14 and database 18 is preferably protected through encryption operations implemented by a core security appliance 20 as described in Secure Network File Access Control System, by Pham et al. (application Ser. No. 10/201,406; filed Jul. 22, 2002; now U.S. Pat. No. 6,678,828), which is incorporated by reference herein.

Communications channels, such as the channel between host computer system 12 and application server 14, are established under the secure control of a security appliance 22 operating through locally installed policy enforcement modules (PEMs) 24, 26. The security appliances 20, 22 may be physically discrete units configured for specific roles or, preferably, configured to support multiple roles as needed by the same physical unit. Even where a security appliance 20, 22 can support multiple roles, additional security appliances 28 can be employed to permit flexibility in the siting of physical devices, such as where a host computer system 30, including locally installed PEM 34, is distant from a security appliance 22 so as to be preferentially associated with a separate security appliance 28.

As illustrated in FIG. 2, a security appliance 42 is employed to securely qualify local operations of application instances executed on host computer systems 44, 46 through the operation of PEMs 48, 50, which are locally installed and executed on the host computer systems 44, 46. Filesystem accesses, such as to a direct attached store 52 or other stores accessible through the network 54, can be qualified down to the level of individual application instances. The PEMs 48, 50 further permit qualification of communications between the host computer systems 44, 46 at any desired trust relation level down to the level of individual application instances. In the preferred embodiments of the present invention, PEMs 48, 50 are configured to intercept certain local and network control and data access operations initiated by local application instances, such as application instance 56, as well as remotely initiated access operations that are directed to the application instance 56 or data store 52. While the specific implementation of the PEMs 48, 50 will vary based on the available operating system specific mechanisms available to intercept function calls and function call returns relative to the operating system, the class of local domain accesses can be described as intercepted by a local system PEM 48A, while the class of network accesses are intercepted by a network PEM 48B.

On intercept of any interprocess communications request, whether a local domain interprocess communications channel (IPC) or network socket request, the requested access operation, along with authentication and authorization information derived from the application instance process context associated with the request, is reported to and processed through a rule-based policy set maintained by the security appliance 42. Based on the request and related information, an applicable set of policy rules are identified for evaluation against the provided information. Access operations if and as permitted under an applicable policy set are then enabled through the PEM to complete. Enabling rules may qualify the access operation, such as to specify the establishment of an encrypted communications channel through which the access operation is permitted and whether encryption operations are to be performed locally by the PEM or remotely through the security appliance 22. Where, similar to as shown in FIG. 1, multiple security appliances 22, 28 are assigned to the PEMs 48, 50, communications between the security appliances 22, 28 permit mutual resolution of access permissions under respectively identified policy sets.

In the particular case of a request to load a file for execution as an application instance 56, a representative file load request is prepared and forwarded by the PEM 48, 50 to the security appliance 42 for evaluation. Preferably, a secure digital signature of the requested file is generated and provided as part of the context authentication and authorization information submitted to the security appliance 42. Although the requested file is typically specified in an operating system call by a filesystem or UNC path, use of the generated signature preferably provides a location independent identification of the file upon which the determination to permit execution is based. In the preferred embodiments of the present invention, the security appliance 42 maintains a pre-verified signature database for the executable files against which policy determinations can be made. Based on the request data provided, the security appliance 42 determines whether the file load request is permitted and informs the PEM 48, 50 to either permit or deny the loading and execution of the requested file.

In the case of requests to create or accept an IPC communications session, the IPC session request and related context dependent information is submitted to the security appliance 42 for evaluation. The response from the security appliance 42 again determines whether the PEM 48, 50 enables the requested communications channel. By considering separately the initial request to create a channel and, on the target host computer system, the permission to first to receive the request and then accept connection to the channel, the security appliance 42 can evaluate the appropriateness of enabling the communications session with respect to both the requesting source and target processes down to the level of the individual source and target application instances and context associated authorizations. Additionally, by intercepting both the creation and acceptance of the communications channel session, the security appliance 42 can coordinate the operation of the source and destination PEMs, typically PEMs 48, in establishing a unique encrypted communications session channel. Preferably, the security appliance 42 stores encryption keys defined through the policy set rules as applicable to the source and target application instances and operates to securely generate a session key unique for the particular communications channel session established. In authorizing the creation of an encrypted communications session, the session key is securely transmitted to the PEMs 48, 50 and used to secure the communication channel for the duration of the session.

A preferred architecture of a security appliance 60 is shown in FIG. 3. A Linux™-based appliance operating system 62 is preferably executed on an Intel™ architecture hardware platform to support a dedicated control program 64 that implements the security function of the security appliance 60. One or more network interfaces 66_{1-N}, each managing the operation of an underlying hardware network interface controller, provides connections to host computer systems 12, 14 and other security appliances 28. Preferably, communications between the PEMs 24, 26, 32 and other security appliances 28 are secured using a secure sockets layer (SSL) or similar secure network protocol. Control connections transmitting request messages and responses can therefore be routed variously through dedicated local networks as well as through shared intranet and public networks. One or more dedicated cipher processors, such as the HiFn™ 7986 security processor, are provided and controlled through cipher processor interfaces 68_{1-N}. These cipher processors permit the security appliance to perform appliance-based encryption and compression operations in support of alternate deployment configurations of the security appliance 60.

A policy database 70 is provided locally on the security appliance 60 to store policy rule sets. A policy parser, implemented as a component of the control program 64, executes to evaluate access requests as received by the security processor 60 against matching policy rule sets. Operation of the control program 64 and management of the policy database 70 are described in Network Media Encryption Architecture and Methods for Secure Storage, by Pham et al. (application Ser. No. 10/016,897; filed Dec. 3, 2001), which is incorporated herein by reference. The policy parser preferably implements decision tree logic to determine whether to allow a access request by matching details of the request and associated context authentication and authorization information against corresponding selectors of the policy rule sets. The type of the request, whether classed as a program load, IPC operation, data file access, or other, determines in part the relevant nature of the policy rule set selectors. Preferably, the stored rules are specified by a system administrator to detail the permitted operations against the various filesystem and communications resources protected by the security processor 60 further qualified by applicable authentication and authorization values and the time ranges within which a rule is operative. The specified authorization values and time ranges are referred to as the rule access attributes.

In the preferred embodiments of the present invention, the authentication data provided in connection with a request processed through the individual PEMs 24, 26, 32 is implicitly derived from the identifier of the process that originates the request. Preferably, a secure identification of the user initiating a particular request is established through use of a pluggable authentication module (PAM) or similar operating system based application security module. In accordance with the present invention, each PEM 24, 26, 32 intercepts the operating system calls made to authenticate local users relative to a current context processes. In particular, the return values for those calls are recorded by the PEM 24, 26, 32. Preferably, on recognition of a successful authentication, the local PEM 24, 26, 32 caches an authentication data record including at least the authenticating process identifier. This authentication data may also record related data including the type of authentication performed and details of the authentication return values. Authentication attempts, including related process context data, can be reported to and recorded by the associated security appliances 60 for auditing and other administrative purposes.

Thus, for requests to be processed through to a security appliance 60, the process identifier associated with the request, as determined on intercept by the local PEM 24, 26, 32 is used to retrieve a corresponding authentication data record. The process identifier is used either directly or by tracing through the chain of parent process identifiers maintained for the process context by the operating system to match an authentication data record process identifier. Where a context relevant authentication has not succeeded, a null authentication data record is returned. The request to the security appliance 60 is then prepared based on the contents of the authentication data record. The authentication data preferably includes the request process identifier and, as applicable, the linking parent process identifiers associated with the authentication data record. This allows the subsequent qualification of the request on the basis of the type of authentication performed and whether and to what extent inherited authentication is acceptable.

Depending on the class type of the request, the access attributes provided with a request can include the operation requested, the request source host computer IP address, the request target host computer IP address, a target resource identified by a path or other identifier, user identification, the source application instance session and process identifiers, and a secure signature and file size of the source application instance. The operative time of the request is provided at least implicitly by the communication protocol used to transfer the request to the security processor 60. Thus, for the class of file access requests, the access attributes provided include the file operation requested, such as open, read, write, append, delete, and move, and the applicable filesystem mount point, path, and file specification. For communications oriented requests, the access attributes provided will include the protocol type of the communication channel requested, the source and target port numbers, and the network operation request, such as open, read, write, and close. Thus, each request presented to the security processor 60 is evaluated by the control program 64 against the permissions matrix defined by the administratively defined policy rules to determine whether the request is permitted. Depending on the determined policy analysis result, a request response containing an enabled, qualified enable, or denied status value is returned to the source PEM 24, 26, 32.

A signature database 72 locally provided on the security appliance 60 is also accessible to the control program 64. Preferably, the signature database stores secure, SHA-1 based signatures for an administratively determined set of executable programs, including associated executable library files. A prototypical database, the National Software Reference Library (NSRL; www.nsrl.nist.gov) which contains signatures for many conventional executable programs, is available from the National Institute of Standards and Technology (NIST). Preferably, as illustrated in FIG. 4, the signature database 72 is maintained as a content addressable list of signatures 82 against which individual signatures can be matched. For the preferred embodiments of the present invention, an intermediate reference data structure 84 is provided to permit association of administratively selected sets of signatures into reference groups. Each reference group is administratively identified by a unique resource identifier. By administrative association, these resource identifiers can be referenced by the resource access attributes of one or more potentially applicable policy rule sets and thereby permit controlled determination of whether execution of the corresponding signed executable is permitted.

The preferred procedure 90 of processing requests received by the control program 64 is shown in FIG. 5. Requests are received 92 variously from the PEMs 24, 26, 32 and analyzed 94 to initially determine the class type of the request as a program load 96, communications operation 98, data file access 100, or other request 102. For a program load request 96, the request provided program signature is looked-up 104 against the signature list 82. A signature look-up failure selects for a default program load policy. A successful look-up 104 identifies the signature as belonging to a reference group. The reference group resource identifier and the authorization and access attributes provided with the request 108 are then used to identify one or more matching policy rules 110. The identified rules are evaluated 112, preferably in the reference group identified order, to determine whether an enabled, conditional enabled, or denied response message being returned 114 to the PEM 24, 26, 32 that originated the request.

The processing of communications requests 98, data access requests 100, and other requests 102 is similar with the principle difference being the request identification 98, 100, 102 and the authorization and access attributes are used directly 108 as a selector of the applicable policy rule sets. Additionally, where the result of the policy evaluation 112 is to enable the request, any ancillary processing specified by the enabling policy rule set, such as to generate encryption session tokens for establishing a secure communications channel, communicate with other security appliances 22, 28, retrieve an encryption key for cipher processing read/write data transfers, or retrieve compression parameters for use in the processing of read/write data, is performed 116. Any applicable product of the ancillary processing, such as encryption session tokens, is then returned 114 as part of the response message sent to the corresponding PEM 24, 26, 32.

In accordance with a preferred embodiment of the present invention, data access requests 100 may involve additional request qualifying data. For example, where the resource request identifies a read or write operation directed against the Windows registry, the qualifying data 108 preferably includes the target registry key, as derived by a PEM 24, 26, 32 relative to the operating system call that would initiate the request. The registry key name, as well as the request associated authentication and authorization data, is used to lookup 110 the applicable policy rules for evaluation 112: Again, the result of the policy evaluation 112 is used to determine the content of the request response message returned 114 by the control program 64.

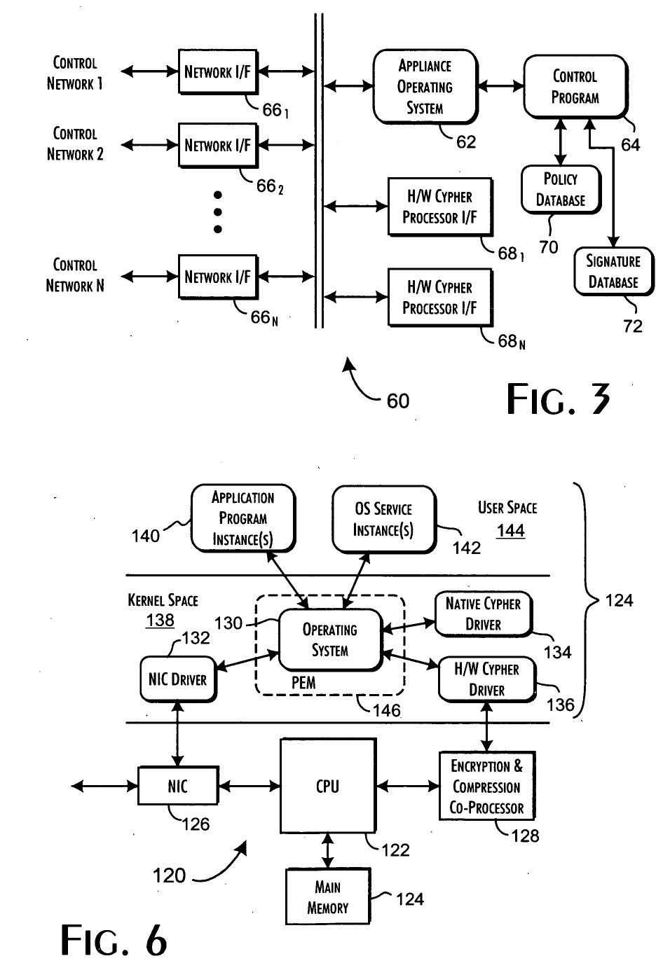

The preferred system architecture 120 of a host computer or server system 12, 14, 30 is shown in FIG. 6. The hardware architecture is preferably any conventional personal computer or workstation system including a host processor 122, main memory 124, and network interface controller (NIC) 126. A security coprocessor 128, supporting computationally intensive encryption and compression operations, is optionally provided. An operating system 130, NIC driver 132, native encryption and compression driver 134, and optional hardware coprocessor driver 136 are executed within a kernel space 138, while program instances, including application and operating system service instances 140, 142, are executed in a user space 144 within the main memory 124.

In accordance with the present invention, a PEM 146 is locally executed within the kernel space 138 as a component permitting interception of selected application program interface (API) and virtual filesystem function calls relative to the operating system 130. The specific mechanism for intercepting the calls is operating system type and version dependent, though generally performed by registering the PEM 146 with the kernel, where function intercepts are natively supported or otherwise by redirection of the call entry points on initialization of the PEM 146.

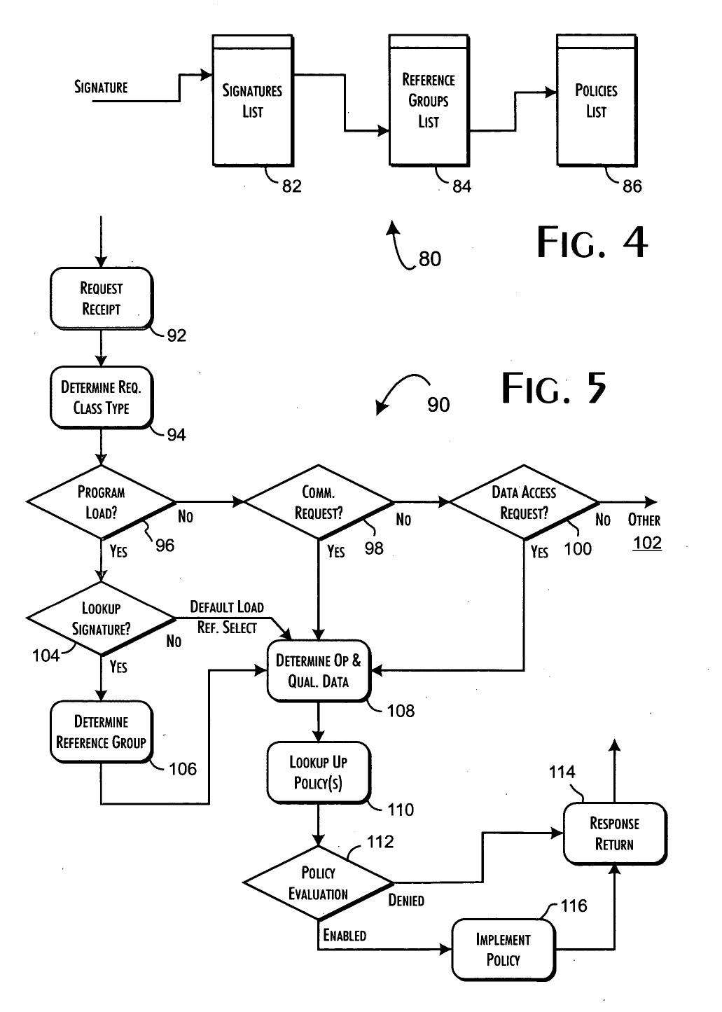

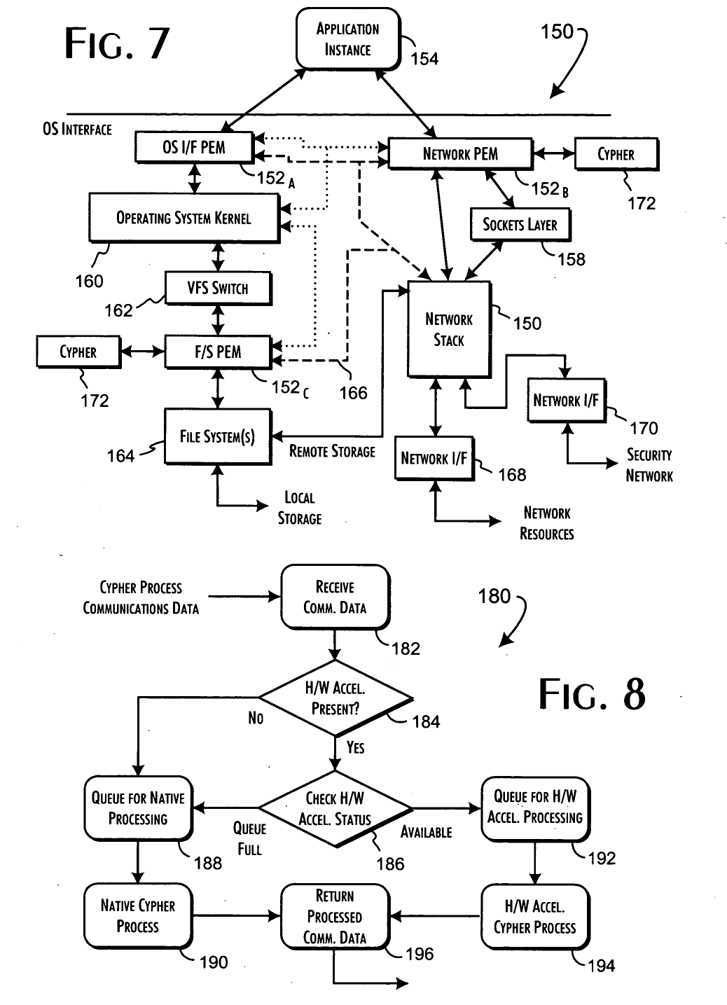

As shown in greater detail in FIG. 7, a PEM 152 is preferably installed as part of the operating system 130 logically architected as an operating system interface PEM 152A, a network call intercept layer PEM 152B, and a filesystem PEM 152C. The operating system interface and network call intercept layer PEMs 152A, 152B are preferably used to qualify and control establishment of local domain (domain socket, pipes, etc.) and network based (tcp, unix_socket, etc.) communications channel sessions. The operating system interface PEM 152A, logically situated over the API call interface, can be further used to qualify any call made to the operating system 130 including authentication calls. The network PEM 152B is located in the logical call path between an application instance 154 and a conventional network communications stack 156, including a sockets layer 158. The file system PEM 152C operates to qualify file access operations, including requests to load executable files and to access data and other files.

As a component of the operating system 130, the operating system kernel 160 is accessible by the operating system and network PEMs 152A, 152B to determine the process context of the application instance 154, including the authentication data and access attributes of both the specific process within which the application instance 154 executes and any context associated parent processes. For purposes of the present invention, a process context is defined as a task parent process, such as a user login shell process or an operating system service factory process, and the set of child processes traceable through parent process identifiers to the task parent process, further related as inheriting the same authentication and access attributes data as the task parent process. The information describing the process context, as retrieved from the operating system kernel 160, ultimately permits establishment of a communications channel preferably specific to the application instance 154 or, alternately, to the member processes of the process context that includes the application instance 154.

The filesystem PEM 152C is similarly implemented as an operating system component to intercept filesystem related calls logically at the level of the virtual filesystem switch (VFS) 162 or equivalent operating system structure. In a preferred embodiment of the present invention, the filesystem PEM 152C utilizes existing interfaces to permit logical insertion between the filesystem switch 162 and one or more conventional filesystems 164, such as the Microsoft® NTFS filesystem, Unix® network filesystem (NFS), or Linux extended version two filesystem (ext2). The operating system kernel 160 is also accessible by the filesystem PEM 152C to determine the process context of the application instance that originates a filesystem request directed to a local or network filesystem 164. Additionally, the filesystem PEM 152C provides for the generation of a secure signature, preferably SHA-1 based, for any executable image loaded from either a local or remote filesystem.

The PEM 152 communicates 166, as needed, with an assigned security appliance 60 through the network stack 150 using either a shared network interface 168 or a private network interface 170. By using the shared network interface 168, the assigned security appliance 60 may be remotely located on any connected intranet or public network accessible by the PEM 152 through the network stack 150. Thus, the PEM 152 may be implemented on a host computer system geographically situated in a completely different location, region, or country relative to the assigned security appliance 60, thereby allowing the security appliance 60 to be physically secured while remotely protecting, through strong encryption, any data accessible through the PEM 152 protected host computer system, including direct attached storage local to the host computer system. The PEM 152 can also be implemented in a notebook or other mobile electronic device that directly or wirelessly connects to a network accessible through the shared network interface 168.

Alternately, the private network interface 170, if provided, can be used to connect one or more host computer systems with an assigned security appliance 60 through a separate security network independent of any public or even intranet-shared network. Use of a private security network permits the connection to be made physically secure, enables use of alternate deployment configurations particularly where clear text data is exchanged with the security appliance 60, and ensures minimal latency in communications between a host computer system and security appliance 60 by removing the albeit small communications load between the PEM 152 and security appliance 60 from the shared network 168 data path nominally used by the application instance 154.

In connection with distinguishing a permitted network-based communications channel request, the assigned security appliance 60 performs the ancillary processing necessary to provide a session specific encryption key to the PEM 152. This session key is then utilized in operating system calls made from the PEM 152 via a cipher driver interface 172 to, as appropriate, encrypt and decrypt data in transit through the PEM 152. The cipher driver interface 172 interoperates with the native encryption and compression driver 134 and hardware coprocessor driver 136, if present, to manage the data processing preferably using the process 80 shown in FIG. 8. In response to receiving data 182, typically inbound or outbound with respect to the application instance 154, the presence of the encryption coprocessor 128 is checked 184. In the absence, failure or queue full state 186 of the encryption coprocessor 128, the received data is queued 188 for native processing 190 through the native encryption and compression driver 134 using the host processor 122. Otherwise, the data is queued 192 for processing 194 by the encryption coprocessor 128, which is the preferred processing path. The processed data is then routed 196 by the PEM 152, directly or indirectly to the application instance 154, network stack 150, or filesystem 164.

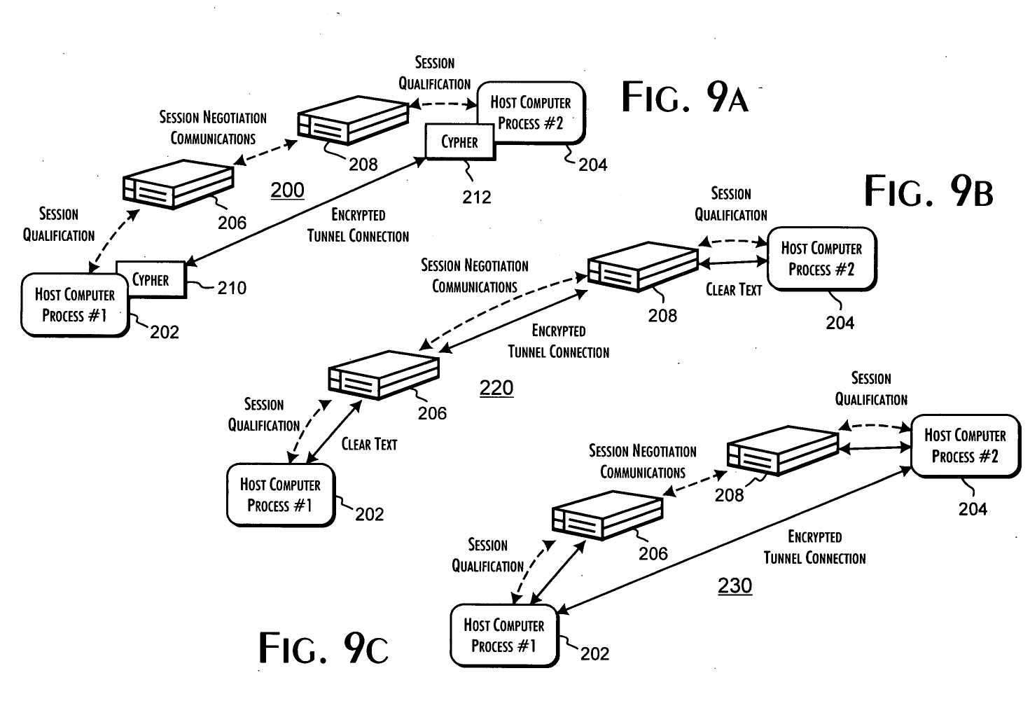

FIGS. 9A, 9B, and 9C illustrated preferred system configurations consistent with the present invention that provide for the secure binding of application instances, through establishment of a secure communications tunnel between securely identified process contexts. In FIG. 9A, illustrating the preferred configuration 200, a direct binding is established by requiring, through operation of PEMs local to the host processes 202, 204, individual and mutual qualification of the process contexts and the application instances, as executed within the host processes 202, 204, by the assigned security appliances 206, 208. In accordance with the present invention, the security appliances 206, 208 may be a single device or two or more distinct physical devices that intercommunicate as needed to coordinate consistent qualification operation with respect to the process contexts including the host processes 202, 204. Individual qualification of the host processes 202, 204 includes qualifying the creation of each the host process 202, 204 for the execution of a securely identified application instance. Mutual qualification includes qualifying the establishment of the encrypted tunnel connection dependent on a combined consideration of the process contexts and application instances. Where a session is qualified and specified by the qualifying policy rule sets to be secure, an encrypted session key is generated by the security appliances 206, 208 and provided to the respective PEMs to enable local encryption operations 210, 212 to permit establishment of a direct, encrypted communications channel.

FIG. 9B shows an alternate configuration 220 where the secure communications channel is established between the security appliances 206, 208, preferably to offload the encryption and compression processing requirements of the channel to the security appliances 206, 208. The PEMs locally executed relative to the host processes 202, 204 qualify the participating process contexts and application instances. The communications data, however, is transferred in clear text or with conventional security encoding between the PEMs and the security appliances 206, 208. Preferably, clear text links are made physically secure.

The alternate configuration 230, shown in FIG. 9C, as with the configuration 220, utilizes a clear text link between the PEMs and security appliances 206, 208 to permit utilization of the encryption and compression processing capabilities of the security appliances 206, 208. Encrypted data is, in this configuration 230, routed back through the PEMs to permit the encrypted tunnel to be established directly between the securely identified process contexts. In this manner, the presence and operation of the security appliances 206, 208 are hidden and the network data packets, as transmitted through the encrypted communications channel are seen to originate from the routed through host computer systems.

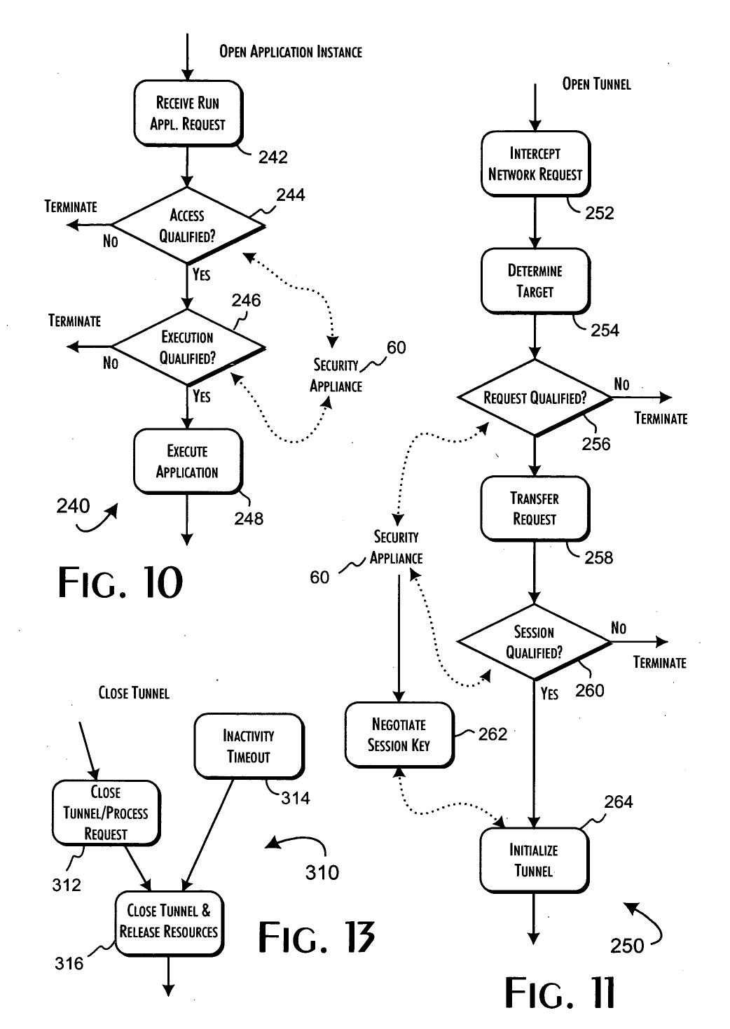

The preferred process 240 of securely qualifying an application instance for execution is shown in FIG. 10. On interception of an operating system kernel 160 call, typically directed to the filesystem 164 to load a binary image of a named program, the locally executed PEM 152 is invoked 242. The authorization data and access attributes, including the execution target process and process context, are determined from the operating system kernel 160. The named program is then peremptorily loaded from the filesystem to permit generation of a secure signature. Alternately, a program file access request is submitted 244 to the assigned security appliance 60 to determine initially whether program file is first accessible for loading in anticipation of execution. The access request is either denied or the PEM 152 is enabled to load the requested program file.

Once a program file is loaded from the filesystem, whether loaded peremptorily or only subject to a successful access request, the program file is held from execution by the PEM 152. A program execution request 246 is then submitted to the assigned security appliance 60. This request preferably includes the secure hash calculated signature of the program image and the authorization data and access attributes determined by the PEM 152 for the program execution request call context. Based on the request, the corresponding policy rule set is evaluated to permit or deny execution of the program file. Where permitted, the permission can be either express or conditional. Particularly in cases where permission is conditional or denied, the ancillary policy implementation 116 preferably implements any administrative actions specified by the policy rule set, which may include actions such as providing an alert message to an administrative console, logging the request and associated data, issuing email and pager notices of the event to administratively set addresses and numbers, and generating execution qualifying control values to be returned to the PEM 152.

Thus, the response returned from the security appliance 60 includes at least a binary value defining whether execution of the program file is to be permitted or denied by the PEM 152. Where denied, the PEM 152 acting through the operating system kernel 160, terminates the execution target process and releases the program file image. Where permitted, the PEM 152 evaluates and implements any conditional execution control values returned from the security appliance 60. In a preferred embodiment of the present invention, these conditional control values determine operative restrictions, such as execution time period and priority, the issuance of local alert dialogs and logging levels, that are then imposed on the execution context of the application instance by the PEM 152. The loaded program file is then released to the operating system 160 to begin execution 248 in the target context as the application instance.

The preferred process 250 of initiating of a secure communication session between source and target program instances is shown in FIG. 11. While described relative to a network stack socket call to establish an communications session between networked host computer systems, the process 250 is equally applicable to a communications session established through a domain socket between processes executing on the same host computer system. The request to create a network communications session is typically issued as a network socket call from a program instance executed on the source host computer system directed to the local socket layer 158. On functional interception of the socket call 252 by the local PEM 152, the call specification is evaluated to determine 254 the target host computer system and a specified port and transport protocol. A connection request then is issued 256 from the source host computer system to the assigned security appliance 60. This connection request preferably includes the call specification data identifying the target host, port, and protocol as well as data, as authentication data and access attributes acquired from the local operating system kernel 160 including data identifying the source process and process context. If the specific connection request is permitted under the applicable policy rules, the PEM 152 is enabled to pass the socket call on to the socket layer 158 to process and further relay a network call 258 to the specified target host computer system.

On the specified target host computer system, the network call is resolved, based on the port and protocol specification, to a communications request directed to a specific program instance executing on the target host computer system. The communications request is functionally intercepted by the target executed PEM 152 and a corresponding session request is issued 260 to the security appliance 60 assigned to the target host computer system. This session request preferably includes the target process and process context related authentication data and access attributes and an identification of the source host computer system, port and protocol, as determined from the operating system kernel 160. Preferably, a secure signature of the binary image of the target program instance is also acquired and provided to the assigned security appliance 60. Depending on the applicable policy rules, qualification of the session request can be made dependent on any combination of the provided session request information. The qualification can be further dependent on the connection request information provided by the source host computer system. The session request information is sufficient for a security appliance 60 assigned jointly to the source and target host computer systems to determine the secure identity of the source program instance. Where separate security appliances 60 are assigned to the source and target host computer systems, the target assigned security appliance 60 obtains sufficient information from the session request to identify and, through secure interoperation, obtain the secure identity of the source program instance from the source assigned security appliance 60. Furthermore, the policy rules can consider other factors, such as time of day and number of current connections established with the target program instance, to finally determine whether the requested communication session is qualified and therefore to be enabled.

Where a communication session is qualified, a session encryption key is generated 262, either directly by a shared security appliance 60 or through negotiation between source and target assigned security appliances 60. For configurations where encryption processing is performed local to the source and target host computer systems, the session key is then passed to the respective PEMs 152. The communications request is then forwarded 264 from the target PEM 152 to the target application instance to complete the initialization of the secure communications session.

Once the communication session is established, protocol appropriate commands and data can be transferred through the communications tunnel represented by the communications session. These protocol commands and data are fully encrypted while in transit between the source and target PEMs 152 utilizing the unique session key generated for the specific combination of source and target applications instances. Thus, based on the generation of the unique session tokens as specified by the applicable policy set rules, a secure communications channel could be shared by multiple, similarly encoded sessions or, preferably, each channel can host a uniquely encrypted communication session securely bound specifically to the participating source and target application instances.

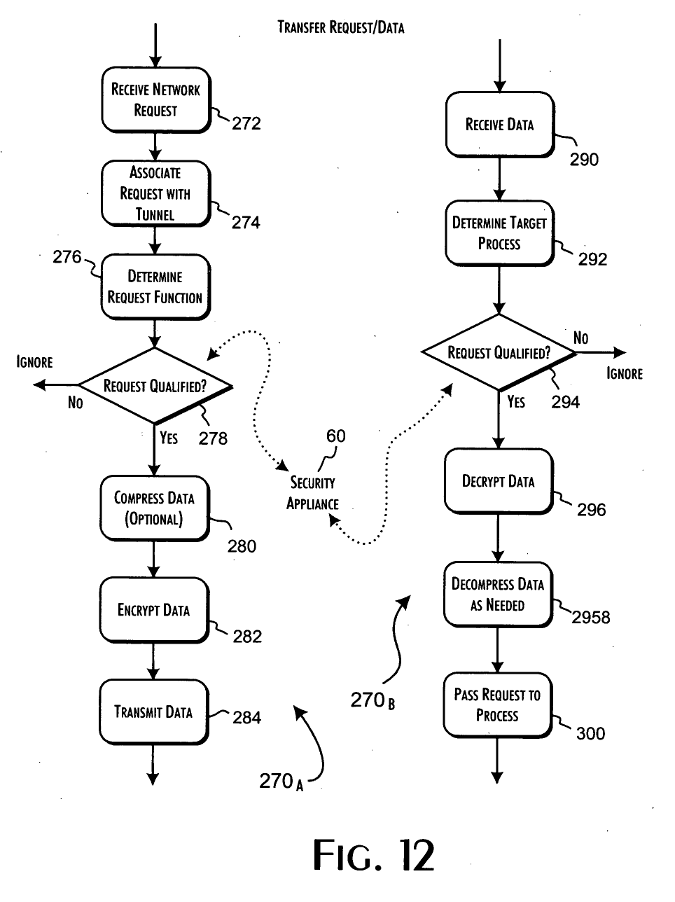

FIG. 12 shows the communication session process flows for transmitting 270A and receiving 270B protocol commands and any associated data, or equivalently protocol command responses and any associated data, through a secure communication channel according to a preferred embodiment of the present invention. From a source program instance, a protocol command and any associated data, or data being returned in response to a command, is functionally intercepted 274 by a PEM 152. By tracing the protocol call to the source program instance, the applicable communications tunnel and session information, including the process, process context and related data, is determined 274 either directly from the local operating system kernel 160 or, alternately, a local transient cache maintained by the PEM 152. This information, combined with an identification of the specified protocol command or command response, is provided 278 via the PEM 152 to the assigned security appliance 60 for qualification against the policy database 70. Specific protocol commands can therefore be used as a basis for determining whether individual protocol transactions within a communications session are permissible between specific, securely bound program instances.

Where the command transaction is permitted, the security appliance returns the session specific session key and, as may be appropriate for low-bandwidth channels, any applicable compression control data. Any data being transmitted is then optionally compressed 280 and the protocol command and data are encrypted 282 using the session key. In accordance with the present invention, each session key is held only transiently by the PEM 152 as necessary for encrypting the corresponding protocol command and data. The encrypted data is then transmitted 284.

On receipt 290, the PEM 152 determines the target process 292 for the received encrypted data, and prepares a qualification request 294 including an identification of the target process, process context and related data. The session key and any applicable compression data are returned, permitting the data to be decrypted 296 and decompressed as needed 298. The decrypted protocol command and any applicable data are then provided to the target program instance 300.

Finally, as generally shown in FIG. 13, an existing communication session can be terminated 310 and the corresponding secure communications tunnel closed by any program instance closing the socket connection at either end of the communications tunnel 312. Alternately, the communications session can be terminated in response to an inactivity timeout 314 determined either by the configuration of the network stack 150 or set and maintained by the PEMs 152 for each of the individual communications sessions managed through the PEMs 152. In each case, the secure communications tunnel is closed and any network stack 150 and PEM 152 resources associated with the tunnel are released 316.

Thus, a system and methods for providing for establishing a secure trust relationship between process contexts, down to the level of individual program instances, has been described. While the present invention has been described particularly with reference to the establishment of encrypted network communications channels between distinct host computer systems, the present invention is equally applicable to the establishment of any trust relationship between program instances and process contexts executed on any computer system.

In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A security server that operates to conditionally enable establishment of a secure interprocess communications session between designated application program instances, said security server comprising:
a) a policy database storing a plurality of policy rules that collectively define the mutual authentication and authorization requirements for establishing a interprocess communications session between first and second application instances; and
b) a security controller interoperative with an operating system that includes an application call interface operative to enable establishment of said interprocess communications session, said security controller being operative to receive predetermined authentication and authorization information from said operating system in connection with a predetermined application call request to establish said interprocess communications session, said security controller being further operative to evaluate said predetermined application call request and said predetermined authentication and authorization information against said plurality of policy rules to conditionally permit the establishment of said interprocess communications session with respect to said first and second application instances.

2. The security server of claim 1 wherein said security controller is operative to establish a session key that defines a unique encryption of communications data transferred through said communications session between said first and second application instances.

3. The security server of claim 2 wherein said security controller is operative to evaluate said predetermined application call request and said predetermined authentication and authorization information against said plurality of policy rules to selectively control establishment of said session key with respect to said first and second application instances.

4. The security server of claim 3 wherein said security controller is operative to provide said session key to said operating system to enable said unique encryption communications data.

5. The security server of claim 4 wherein said first and second application instances are executed on a common host computer system.

6. The security server of claim 1 wherein wherein said security server is coupleable to said operating system through a network communications connection.

7. An interprocess communications security system enabling secure communications sessions to be established between designated application instances, said interprocess communications security system comprising:
a) a first computer system coupleable to a communications network, wherein said first computer system includes a first operating system operative to support execution of a first application instance by said first computer system, said first operating system including a first policy enforcement module operative to qualify predetermined communications calls made between said first application instance and said first operating system;
b) a second computer system coupleable to a communications network, wherein said second computer system includes a second operating system operative to support execution of a second application instance by said second computer system, said second operating system including a second policy enforcement module operative to qualify predetermined communications calls made between said second application instance and said second operating system; and
c) a security appliance coupleable to said first and second computer systems through said communications network, said security appliance being interoperable with said first and second policy enforcement modules to mutually authenticate said first and second application instances to conditionally conduct interprocess communications.

8. The interprocess communications security system of claim 7 wherein said security appliance is further interoperable with said first and second policy enforcement modules to enable encryption processing of interprocess communications exchanged between said first and second application instances.

9. The interprocess communications security system of claim 8 wherein said security appliance is operative to determine an encryption token with respect to the mutual authentication of said first and second application instances, to provide said encryption token to said first and second policy enforcement modules for use in encrypting processing of interprocess communications exchanged between said first and second application instances.

10. The interprocess communications security system of claim 9 wherein said security appliance includes a policy database storing a plurality of policy rules and a control program operative to evaluate said plurality of policy rules, wherein said first and second policy enforcement modules are operative to provide said security appliance with predetermined information associated with said first and second application instances in connection with a predetermined communications call request by said first application instance to establish interprocess communications with said second application instance, and wherein said security appliance conditionally enables establishment of an interprocess communications session between said first and second application programs in response to said predetermined communications call request dependent on an evaluation of said plurality of policy rules with respect to said predetermined information.

11. The interprocess communications security system of claim 10 wherein said predetermined information includes a secure identification of said first and second application instances and wherein said secure identification is used to mutually authenticate said first and second application instances.

12. The interprocess communications security system of claim 11 wherein said security appliance includes a signature database storing a plurality of secure signatures, wherein said predetermined information includes secure signatures for said first and second application instances, and wherein said security appliance is operative to compare the secure signatures of said first and second application instances to said plurality of secure signatures.

13. An interprocess communications security system enabling secure trust relationships to be established at any level down to the level of individual application instances as executed on respective host computer systems interconnected by a communications network, said system comprising:
a) a first host computer operative to support execution of a first application instance within a first predefined process context;
b) a second host computer system operative to support execution of a second application instance in a second predefined process context;
c) control means, provided with respect to said first and second host computer systems, for establishing communications channels between said first and second host computer systems including a predetermined communications channel conducting communications between said first and second predefined process contexts, said control means being responsive to predetermined information identified with said first and second predefined process contexts to determine a session encryption key for use exclusively in encryption processing of communications conducted through said predetermined communications channel.

14. The interprocess communications security system of claim 13 wherein said predetermined information identified with said first and second predefined process contexts includes secure identifications of said first and second application instances.

15. The interprocess communications security system of claim 14 wherein said control means provides for a policy-based evaluation of said predetermined information identified with said first and second process contexts.

16. The interprocess communications security system of claim 15 wherein said first and second predefined process contexts are established on said first and second computer systems by first and second operating systems and wherein said control means includes policy enforcement means implemented in combination with said first and second operating systems to conditionally enable establishment of said predetermined communications channel subject to said policy-based evaluation.

17. The interprocess communications security system of claim 16 wherein said control means includes a security server computer system operable to receive said predetermined information, to perform said policy-based evaluation, and to control said policy enforcement means in conditionally enabling establishment of said predetermined communications channel.

18. The interprocess communications security system of claim 17 wherein said security server computer system determines said session encryption key.

19. The interprocess communications security system of claim 18 wherein said session encryption key is provided to said policy enforcement means to perform encryption processing for communications conducted between said first and second process contexts.

20. A method of binding application execution contexts on network connected computer systems through a secure communications channel, said method comprising the steps of:
a) first enabling execution of a first application instance on a first computer system dependent on a first security assessment of a first application context within which said first application instance is executable;
b) second enabling execution of a second application instance on a second computer system dependent on a second security assessment of a second application context within which said second application instance is executable;
c) third enabling communications between said first and second application instances dependent on a mutual security assessment of said first and second application contexts; and
d) selectively establishing an encrypted communications channel between said first and second application instances wherein use of said encrypted communications channel is enabled by a session key shared between said first and second application contexts.

21. The method of claim 20 wherein data, representative of said first and second application contexts, is communicated to a security server, said method further comprising the step of evaluating said data to perform said first, second, and mutual assessments of said first and second application contexts.

22. The method of claim 21 further comprising the step of determining, by said security server, said session key.

23. The method of claim 22 further comprising the step of communicating said session key from said security server to said first and second application contexts, wherein communications through said encrypted communications channel are transferred directly, relative to said security server, between said first and second application contexts.

24. A method of securely binding communications between processes, wherein application instances, within respective processes, are executed on computer systems in process execution contexts, said method comprising the steps of:
a) intercepting communications between first and second predetermined process execution contexts; and
b) encrypting intercepted network communication transmissions and decrypting intercepted communication receptions utilizing an encryption key uniquely established based on an evaluation of authorization and authentication information descriptive of said first and second predetermined process execution contexts.

25. The method of claim 24 wherein sets of one or more related processes are executed in process execution contexts, and wherein said step of intercepting communications includes the steps of identifying said first and second predetermined process execution contexts as a unique communication session and of obtaining a session encryption key specific to said secure communications session for said network communication.

26. The method of claim 25 wherein said session encryption key is unique to said unique communications session.

27. The method of claim 26 further comprising the step of determining said session encryption key uniquely in connection with the establishment of said unique communications session.

28. The method of claim 27 further comprising the step of requesting, with respect to said first and second predetermined execution contexts, said session key from a security server.

29. The method of claim 28 wherein said security server is an independent computer system relative to the computer systems providing for the execution of said first and second process execution contexts, wherein said step of requesting provides for the transfer of predetermined authorization and authentication information descriptive of said first and second execution contexts, including secure identifications of first and second application instances, to said security server, and wherein said security server performs said step of determining dependent on said predetermined authorization and authentication information.

30. A method of securely binding process communications, said method comprising the steps of:
a) intercepting, on first and second host computer systems, communications data directed between first and second application instances executed respectively on said first and second host computers; and
b) transferring the intercepted communications data, in encrypted form, between said first and second application instances, wherein the intercepted communications data is encrypted using an encryption key determined specific to said first and second application instances.

31. The method of claim 30 wherein said step of intercepting is performed transparently with respect to said first and second application instances.

32. The method of claim 31 further comprising the step of requesting said encryption key from a security server computer system separate from said first and second host computer systems, said step of requesting including the steps of communicating predetermined identification data, including an identification of said first and second application instances, to said security server computer system and of selectively receiving said encryption key.

33. The method of claim 32 further comprising the step of determining, by said security server computer system, said encryption key specific to said predetermined identification data.

34. A system of securing communications between application instances executable on respective host computer systems, said system comprising:
a) first and second computer systems operable to execute respective pluralities of application instances; and
b) first and second secure communications modules respectively executable by said first and second computer systems, said first and second secure communications modules being operative to identify discrete communications sessions between specific pairs of application instances among said pluralities of application instances and establish encrypted communications channels between said first and second secure communications modules for respective communication sessions.

35. The system of claim 34 further comprising a security server computer system operative to provide a distinct session encryption key to said first and second secure communications modules for respective communication sessions.

36. The system of claim 35 wherein said security server computer system includes a policy database, wherein said first and second secure communications modules are coupleable to said security server computer system to provide predetermined request data with respect to a predetermined communication session, wherein said server computer system is operative to evaluate said predetermined request data against said policy database and selectively return said distinct session encryption key for said predetermined communication session.

37. The system of claim 36 wherein said predetermined request data includes first request data including a first identification of a first application instance and second request data including a second identification of said second application instance.

38. The system of claim 37 wherein said first and second identifications are secure identifications.

39. The system of claim 38 wherein said predetermined request data identifies provides user identification, user authentication, and application instance identification information for said first and second application instances.

40. A system for controlling the execution and mutual communication between remotely executing programs, said system comprising:
a) a first control program executable by a first computer system operative, by execution of a first operating system, to support execution of a first predetermined program, said first control program operative to process first predetermined data transfers between said first predetermined program and said first operating system;
b) a second control program executable by a second computer system operative, by execution of a second operating system, to support execution of a second predetermined program, said second control program operative to process second predetermined data transfers between said second predetermined program and said second operating system; and
c) a security server coupleable to said first and second predetermined programs to selectively enable processing of said first and second predetermined data transfers dependent on security values evaluated by said security server with respect to said first and second predetermined programs.

41. The system of claim 40 wherein said first and second control programs are further respectively operative to provide first and second sets of security values, corresponding respectively to said first and second predetermined programs, to said security server.

42. The system of claim 41 wherein said security server is operative to enable processing of said first and second predetermined data transfers where said first and second predetermined data transfers provide for the communication of data between said first and second predetermined programs dependent on the mutual evaluation of said first and second sets of security values.
